(19) United States
(12) Patent Application Publication
(10) Pub. No.: US 2009/0172133 A1
(43) Pub. Date: Jul. 2, 2009

(54) CONTROL POINTS FOR CONTROLLING DEVICES IN A NETWORK

(75) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/719,865

(22) PCT Filed: Nov. 18, 2005
(86) PCT No.: PCT/IB05/53818

§ 371 Date: May 22, 2007

(30) Foreign Application Priority Data
Nov. 25, 2004 (EP) 04106057.5

(51) Int. Cl. G06F 15/177

(52) U.S. Cl. 709/220

(57) ABSTRACT

The present invention relates to a method for a control point of initiating actions on a device in a communication network comprising at least two control points both adapted to control said device. Further, the present invention relates to a method for a device of initiating actions on said device in a communication network comprising at least two control points both adapted to control said device. Further, the present invention relates to a control point of initiating actions on a device in a communication network comprising at least two control point both adapted to control said device. Further, the present invention relates to a device in a communication network comprising at least two control points both adapted to control said device based on action requests received from a control point along with control point identification.

The present invention relates to a method for a control point of initiating actions on a device in a communication network comprising at least two control points both adapted to control said device. Further, the present invention relates to a method for a device of initiating actions on said device in a communication network comprising at least two control points both adapted to control said device. Further, the present invention relates to a control point for initiating actions on a device in a communication network comprising at least two control points both adapted to control said device. Further, the present invention relates to a device in a communication network comprising at least two control points both adapted to control said device based on action requests received from a control point along with control point identification.

“Universal Plug and Play” (UPnP) is an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. Universal Plug and Play is a distributed, open networking architecture that leverages TCP/IP and the Web technologies, to enable seamless proximity networking in addition to control and data transfer among networked devices in the home, office, and public spaces. The UPnP standard is defined in the document “Universal Plug and Play Device Architecture”, Version 1.0, Jun. 8, 2000, (c) 1999-2000 Microsoft Corporation.

Typically, control points are part of devices that interact directly with the end-user. For example, in Philips iPronto advanced remote control prototypes shown to Philips customers in the CES world tour, the iPronto acts as a control point and is able to control all devices in the network.

Control points cannot directly correlate their control actions with the events they receive. This can lead to consistency problems if multiple control points try to control a single device, and control points are not carefully programmed to deal with delays of events and events of multiple control points.

A typical error that occurred with a single control point and a device that delays event notifications is the following: a control point that issues an action to set the volume of a device repeatedly might display that value in its user interface based on the control action response from the device. Similarly, whenever a control point receives an event notification that includes the latest update to the volume, it might adapt the user interface to reflect this value. Since the control point both receives control action responses and event notifications indicating the status of the devices, and since the event notification can be delayed, the control point does not now which status is the most recent status. The problem could therefore be that, by raising the volume, several set-volume actions are given in sequence and interleaved with that sequence, delayed notifications come in and the volume setting starts jumping around.

A second type of error that can occur is with two or more control points that issue conflicting actions. For example, two control points might try to play a different movie on the same UPnP TV. If their algorithm is stubborn (restart the movie if it is stopped, stop any other movie to start the movie), the system can go into a lifelock, repeatedly starting and stopping movies. UPnP offers no mechanism for control points to negotiate who controls the TV, nor do they provide a mechanism for users to negotiate if they are not in the same physical location.

It is therefore an object of the present invention to provide a solution to the above-mentioned problems.

This is obtained by a method for a control point of initiating actions on a device in a communication network comprising at least two control points both adapted to control said device, wherein said controlling is performed by transmitting a control message to said device, said control message comprising an action request for initiating an action on said device and wherein said action comprises a unique action request identifier uniquely identifying said action request, and further wherein said device is adapted to transmit an event notification to said control points when said action has been initiated wherein said event notification indicates an event caused by at least said initiated action and wherein said event notification comprises said unique action request identifier.

In an embodiment said unique action request identifier comprises information uniquely identifying said action.

In an embodiment said unique action request identifier comprises information uniquely identifying said control point transmitting said action request.

Thereby, an event caused by the action request is known to the control points. It follows that the control points can correlate their control actions so that e.g. conflicting actions between the control points are avoided.

In an embodiment said control message further comprises additional information intended to be received by control points in said communication network and adapted to be transmitted from said device as part of said event notification. Thereby, through said additional information said control points can communicate indirectly.

In an embodiment, said control message further comprises stable control point identities. Thereby, a user of control points which are stable, i.e. which have unchanged identity, can associate a physical device with it, e.g. “the iPronto of Mommy”, and possibly associate an icon. Controllers, i.e. control points, can track the history of other controllers using this identity and assign default behaviors (e.g. if controller A and B both try to control the UPnP TV, controller B gives up automatically). Changing identities can be used for anonymous access in more public environments.

In an embodiment, said additional information further comprises an identification of the intentions of said control point Therefore, scheduling related information can be transferred with the control message to other control points. This may be done by either informing the control point directly or the user using the control point with e.g. any kind of message. The intentions can be refined, e.g. if the control point issues a certain command from a known sequence of commands, it can indicate this sequence already in the first command This is relevant for e.g. setting up an AV stream, which requires issuing multiple commands on multiple devices in sequence.

In an embodiment, said additional information further comprises an identification of the communication address of said control point, adapted to be transmitted as part of said event notification. Thereby, the control points can be informed which control point initiated said action request. This enables the control points to communicate directly with each other.

In an embodiment, said additional information further comprises a unique action-invocation ID. Thereby, the control points can detect that the occurrence of actions which are invoked is equal to the order of the related events which are generated. This simplifies the state of the control point.

The invention further relates to a computer-readable medium having stored therein instructions for causing a processing unit to execute a method as described above.

The invention also relates to a method for a device of initiating actions on said device in a communication network comprising at least two control points both adapted to control said device, wherein said controlling is performed by transmitting a control message to said device, said control message comprising an action request for initiating an action on said device and comprises a unique action request identifier uniquely identifying said action request, and further wherein said device transmit an event notification to said control points when said action has been initiated, wherein said event notification indicates an event caused by at least said initiated action and wherein said event notification comprises said unique action request identifier.

Therefore, through said event notification transmitted by said device it is known by said control points which event was initiated. It follows that the control points can correlate their control actions on said device so that e.g. conflicting actions between the control points is avoided.

In an embodiment, said unique action request identifier comprises information uniquely identifying said action. Thereby, detailed information about the initiated action is known by said control points.

In an embodiment, said unique action request identifier comprises information uniquely identifying said control point transmitting said action request. Thereby, said control points can identify which control point initiated said action.

In an embodiment said event notification further comprises additional information intended to be received by control points in said communication network, said additional information comprised in said control message received from said control point. Thereby, through said additional information said control points can communicate indirectly.

In an embodiment said control point are adapted to subscribe to event notifications and said device transmits said event notification to control points subscribing to said event notifications. Thereby, it is not necessary to send said event notification to all control points. The control points may communicate internally and share said event notifications.

In an embodiment said event notification comprises at least two unique action request identifiers each identifying an action request initiating an action causing at least a part of said event. Thereby, said control points are informed about which control actions caused said event. This may enhance the correlation between said control points.

In an embodiment said at least two unique action request identifiers identify action requests initiating actions on different devices. Thereby, said control points are informed about the various control actions performed by the various devices, which enhances the correlation between the control points.

The invention further relates to a computer-readable medium having stored therein instructions for causing a processing unit to execute a method as described above.

The invention also relates to a control point for initiating actions on a device in a communication network comprising at least two control points both adapted to control said device by transmitting a control message to said device, wherein said control point comprises:

processing means for generating said control message to at least said device, said control message comprising an action request adapted for initiating said action on said device and a unique action request identifier, uniquely identifying said action request,

transmitting means for transmitting said control message to said device, wherein said device is adapted to transmit an event notification to said control point when at least said action has been initiated, wherein said event notification indicates an event caused by at least said initiated action and wherein said event notification comprises said unique action request identifier.

The invention also relates to a device in a communication network comprising at least two control points both adapted to control said device by transmitting a control message to said device, wherein said control message comprises an action request adapted for initiating an action on said device and a unique action request identifier, uniquely identifying said action request, wherein said device comprises:

processing means for generating an event notification wherein said event notification indicates an event caused by at least said initiated action and wherein said event notification comprises said unique action request identifier,

transmitting means for transmitting said event to said control points, when said action has been initiated.

In the following preferred embodiments of the invention will be described referring to the Figures, where

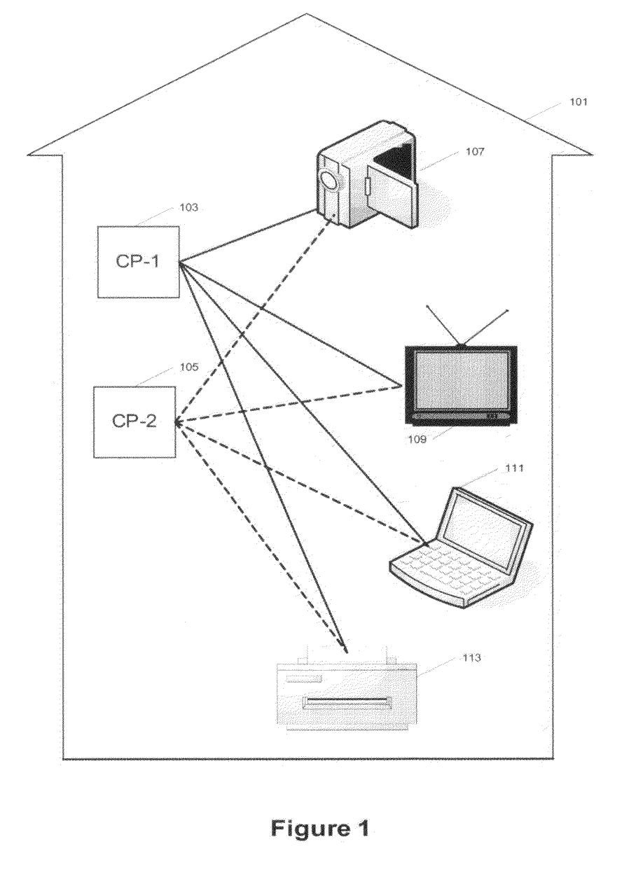

FIG. 1 illustrates one embodiment of the present invention showing a network, which can be UPnP network, comprising two control points,

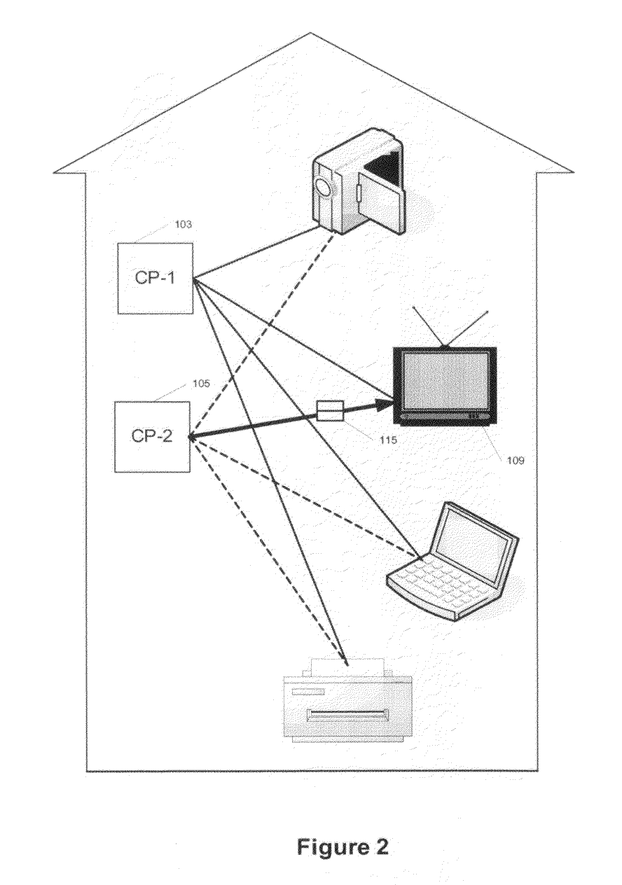

FIG. 2 shows where a control point 2 sends a control message comprising an action request for initiating an action on a TV,

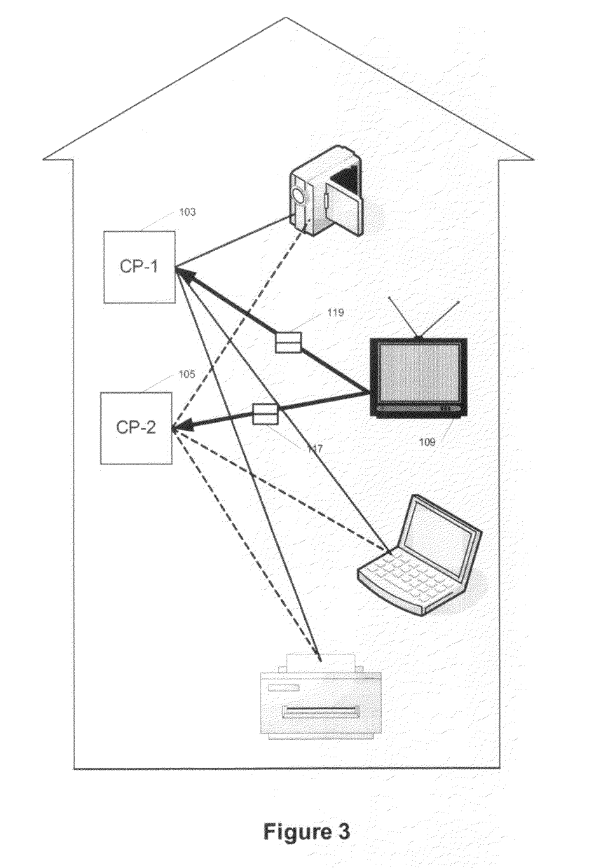

FIG. 3 shows where an event notification is sent to both control points 1 and 2, and

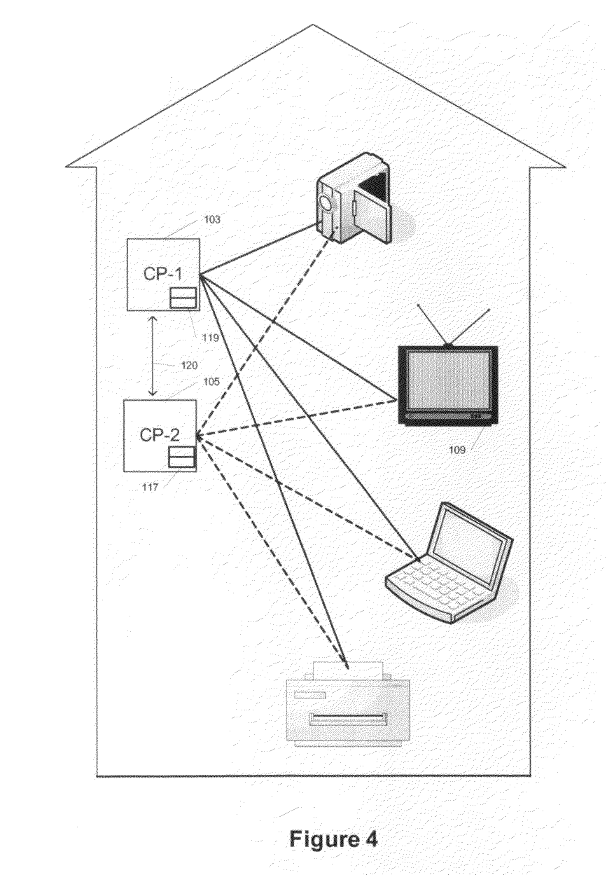

FIG. 4 shows where the two control points 1 and 2 have set up a direct communication, where they may correlate their control actions.

FIG. 1 illustrates one embodiment of the present invention showing a network 101, which can be UPnP network, comprising two control points 103, 105 adapted to initiate actions on four devices 107, 109, 111, 113, which can be UPnP devices. The controlling comprises transmitting a control message to one or more of the devices 107, 109, 111, 113, which respond by initiating a control action and subsequently sending an event notification indicating the event caused by at least the initiated action. In one embodiment the event notification indicates an event caused by at least said initiated action. In another embodiment as illustrated in FIGS. 1-4 it is assumed that the event notification comprises the initiated action along with identification of the control point which initiating the action. By doing so, the control points 103, 105 can identify which control point caused a particular event for a particular device. Based on the event notification, the control points 103, 105 can correlate their control actions by communicating with each other. It follows that e.g. conflicting actions between the control points are avoided.

In one embodiment the control points may or may not be in a subscription for receiving an event notification. As an example, only one control point may be in a subscription for receiving an event notification. This event notification may then be shared with other control points (i.e. if more than one) e.g. via wireless communication channel (see FIG. 4).

FIG. 2 shows where a control point CP-2 105 sends a control message 115 comprising an action request for initiating an action on the TV 109. This action request may comprise any kind of action, e.g. turning on the TV, setting up the volume of the TV 109 etc. After initiating the action, the TV transmits an event notification 117, 119 to the control points 103, 105, as illustrated in FIG. 3, that the action has been performed. Here, it is assumed that both the control points 103, 105 have a subscription for receiving such an event notification. A single event notification may be related to multiple actions. An example is the action request to turn on “channel five”. This event can comprise two actions, one where the TV 109 is turned on, and the second where it is switched to channel five. The resulting event notification could in this case be “Channel 5, control point CP-2 105 is in control”. Another example of multiple actions which result in a single event is where e.g. actions A1 and A2 are performed by one device D1 and subsequently action A3 performed by device D2.

In an embodiment the control message further comprises information to be interpreted by a user of said control point, e.g. “Joe is controlling the TV, hands off!”, and this control message is forwarded to one or more of the other control points. This can be useful if users are not in the same room, but control the same device over the network. An example of implementing this embodiment is where a user sends a message along with the action request saying e.g., “Joe will be watching the TV 109 for the next hour”. In this way, a user which is not in the same room will receive this message along with the event notification and therefore that Joe is now in control of the TV 109. This may be implemented where e.g. only one device is being used and which is controllable by use of two (or more) control points.

FIG. 3 shows where the event notification 117, 119 is sent to both control points CP-1 and CP-2 103, 105. As previously mentioned, the event notification 117, 119 comprises identification of the initiated action and the control point identification identifying the control point initiating the action, i.e. in this case control point CP-2 105. Thereby, the control point CP-1 103, which did not initiate the action, can identify that control point CP-2 105 is controlling the TV 109.

FIG. 4 shows where the two control points CP-1 and CP-2 103, 105 have set up a direct communication 120, where they may correlate their control actions based on the event notifications 117, 119. One example of such a correlation is where the control points negotiate about device usage.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements and by means of a suitably programmed computer. In a device claim enumerating several means, several of these means can be embodied by one and the same item of hardware. The mere fact that certain measures are recited in mutually different, dependent claims does not indicate that a combination of these measures cannot be used to advantage.

1. A method for a control point of initiating actions on a device in a communication network comprising at least two control points both adapted to control said device, wherein said controlling is performed by transmitting a control message to said device, said control message comprising an action request for initiating an action on said device and wherein said action comprises a unique action request identifier uniquely identifying said action request, and further wherein said device is adapted to transmit an event notification to said control points when said action has been initiated wherein said event notification indicates an event caused by at least said initiated action and wherein said event notification comprises said unique action request identifier.

2. A method according to claim 1, wherein said unique action request identifier comprises information uniquely identifying said action.

3. A method according to claim 1, wherein said unique action request identifier comprises information uniquely identifying said control point transmitting said action request.

4. A method according to claim 1, wherein said control message further comprises additional information intended to be received by control points in said communication network and adapted to be transmitted from said device as part of said event notification.

5. A method according to claim 4, wherein said additional information comprises identities of stable control point in said communication network.

6. A method according to claim 4, wherein said additional information comprises an identification of the intentions of said control point.

7. A method according to claim 4, wherein said additional information comprises an identification of the communication address of said control point, adapted to be transmitted as part of said event notification.

8. A method according to claim 4, wherein said additional information comprises a unique action-invocation ID.

9. A computer-readable medium having stored therein instructions for causing a processing unit to execute the method of claim 1.

10. A method for a device of initiating actions on said device in a communication network comprising at least two control points both adapted to control said device, wherein said controlling is performed by transmitting a control message to said device, said control message comprising an action request for initiating an action on said device and comprises a unique action request identifier uniquely identifying said action request, and further wherein said device transmit an event notification to said control points when said action has been initiated, wherein said event notification indicates an event caused by at least said initiated action and wherein said event notification comprises said unique action request identifier.

11. A method according to claim 10, wherein said unique action request identifier comprises information uniquely identifying said action.

12. A method according to claim 10, wherein said unique action request identifier comprises information uniquely identifying said control point transmitting said action request.

13. A method according to claim 10, wherein said event notification further comprises additional information intended to be received by control points in said communication network, said additional information comprised in said control message received from said control point.

14. A method according to claim 10, wherein said control point are adapted to subscribe to event notifications and said device transmits said event notification to control points subscribing to said event notifications.

15. A method according to claim 10, wherein said event notification comprises at least two unique action request identifiers each identifying an action request initiating an action causing at least a part of said event.

16. A method according to claim 15, wherein said at least two unique action request identifiers identify action requests initiating actions on different devices.

17. A computer-readable medium having stored therein instructions for causing a processing unit to execute the method of claim 10.

18. A control point for initiating actions on a device in a communication network comprising at least two control points both adapted to control said device by transmitting a control message to said device, wherein said control point comprises:
processing means for generating said control message to at least said device, said control message comprising an action request adapted for initiating said action on said device and a unique action request identifier, uniquely identifying said action request,
transmitting means for transmitting said control message to said device, wherein said device is adapted to transmit an event notification to said control point when at least said action has been initiated, wherein said event notification indicates an event caused by at least said initiated action and wherein said event notification comprises said unique action request identifier.

19. A device in a communication network comprising at least two control points both adapted to control said device by transmitting a control message to said device, wherein said control message comprises an action request adapted for initiating an action on said device and a unique action request identifier, uniquely identifying said action request, wherein said device comprises:
processing means for generating an event notification wherein said event notification indicates an event caused by at least said initiated action and wherein said event notification comprises said unique action request identifier,
transmitting means for transmitting said event to said control points, when said action has been initiated.
